(19) United States
(12) Patent Application Publication
(10) Pub. No.: US 2006/0214016 A1
(43) Pub. Date: Sep. 28, 2006

(54) Hands-free faucet

(76) Inventors: Edward Erdely, Aliso Viejo, CA (US); Michael Maridakis, Garden Grove, CA (US); Alston E. Williams, Irvine, CA (US)

Correspondence Address: TAYLOR & AUST, P.C., 12029 EAST WASHINGTON STREET, INDIANAPOLIS, IN, 46229, US

(21) Appl. No.: 11/378,805

(22) Filed: Mar. 17, 2006

Related U.S. Application Data
(60) Provisional application No. 60/663,160, filed on Mar. 18, 2005.

(51) Int. Cl. G05D 23/13

(52) U.S. Cl. 236/12.12

(57) ABSTRACT

A faucet includes a spout defining a primary water path. A water path is coupled to the primary water path of the spout. An electrically-operated valve is coupled in the water path to control a water flow through the water path. A control device is communicatively coupled to the electrically-operated valve. The control circuit includes a sensor that sends a signal to the electrically-operated valve to place the electrically-operated valve in an ON state when the sensor detects the presence of an object.

### CROSS REFERENCE TO RELATED APPLICATIONS

This is a non-provisional application based upon U.S. provisional patent application Ser. No. 60/663,160, entitled “HANDS-FREE FAUCET”, filed Mar. 18, 2005.

### FIELD OF THE INVENTION

The present invention relates to faucets, and, more particularly, to a faucet configured to facilitate hands-free use.

### BACKGROUND OF THE INVENTION

A faucet assembly typically includes a spout and a pair of valve operators, e.g., handles. The valve operators are connected to respective hot and cold water valves, and in turn, typically operate the valves by manual rotation of the valve operators.

### SUMMARY OF THE INVENTION

The present invention provides a faucet configuration that facilitates hands-free use.

The invention, in one form thereof, is directed to a faucet. The faucet includes a spout defining a primary flow path. A first flow path is coupled to the primary flow path of the spout. A first solenoid-operated valve is coupled into the first flow path to control a first water flow through the first flow path. A second flow path is coupled to the primary flow path of the spout. A second solenoid-operated valve is coupled into the second flow path to control a second water flow through the second flow path. A control device is communicatively coupled to each of the first solenoid-operated valve and the second solenoid-operated valve. The control device includes a sensor that sends a signal to the first solenoid-operated valve to place the first solenoid-operated valve in an ON state and to the second solenoid-operated valve to place the second solenoid-operated valve in an ON state when the sensor detects the presence of an object. A temperature control is coupled into the first flow path and coupled into the second flow path to regulate a water temperature in the primary flow path.

The invention, in another form thereof, is directed to a faucet. The faucet includes a spout defining a primary flow path. A first flow path is coupled to the primary flow path of the spout. A first solenoid-operated valve is coupled into the first flow path to control a first water flow through the first flow path. A second flow path is coupled to the primary flow path of the spout. A second solenoid-operated valve is coupled into the second flow path to control a second water flow through the second flow path. A control device is communicatively coupled to each of the first solenoid-operated valve and the second solenoid-operated valve. The control device includes a sensor that sends a signal to the first solenoid-operated valve to place the first solenoid-operated valve in an ON state and to the second solenoid-operated valve to place the second solenoid-operated valve in an ON state when the sensor detects the presence of an object. A first auxiliary flow path is connected in parallel with the first solenoid-operated valve. A second auxiliary flow path is connected in parallel with the second solenoid-operated valve. A flow control device is coupled into the first auxiliary flow path and into the second auxiliary flow path.

The invention, in another form thereof, is directed to a faucet assembly. The faucet assembly includes a spout defining a primary flow path. A first valve assembly provides water flow regulation and water temperature regulation. The first valve assembly has a first input port, a second input port and a first output port. A first water supply path is coupled to the first input port of the first valve assembly. A second water supply path is coupled to a second input port of the first valve assembly. A third flow path is coupled between the output port of the first valve assembly and the primary flow path of the spout. A second valve assembly provides at least one of water flow regulation and water temperature regulation. The second valve assembly has a third input port, a fourth input port and a second output port. A fourth flow path is coupled between the third input port and the first water supply path. A fifth flow path is coupled between the fourth input port and the second water supply path. A sixth flow path is coupled between the second output port of the second valve assembly and the primary flow path of the spout. An electrically-operated valve is coupled into the sixth flow path to control a water flow through the second valve assembly. A flow sensor is coupled into the third flow path to detect a water flow through the first valve assembly. An object sensor detects a presence of an object. A switching device is communicatively coupled to the flow sensor, the object sensor, and the electrically-operated valve. The switching device is configured such that if a water flow is detected in the third flow path by the flow sensor, then the electrically-operated valve is retained in an OFF state.

The invention, in another form thereof, is directed to a faucet assembly. The faucet assembly includes a spout defining a primary flow path. A first valve assembly provides at least one of water flow regulation and water temperature regulation. The first valve assembly has a first electrically-operated valve, a second electrically-operated valve, a first input port, a second input port, and a first output port. The first electrically-operated valve is coupled between the first input port and the first output port and the second electrically-operated valve is coupled between the second input port and the first output port. A first water supply path is coupled to the first input port of the first valve assembly. A second water supply path is coupled to the second input port of the first valve assembly. A third flow path is coupled between the output port of the first valve assembly and the primary flow path of the spout. A second valve assembly provides water flow regulation and water temperature regulation, the second valve assembly having a third input port, a fourth input port and a second output port. A fourth flow path is coupled between the third input port and the first water supply path. A fifth flow path is coupled between the fourth input port and the second water supply path. A sixth flow path is coupled between the second output port of the second valve assembly and the primary flow path of the spout. A flow sensor is coupled into the sixth flow path for detecting a water flow through the second valve assembly. An object sensor detects a presence of an object. A switching device is communicatively coupled to the flow sensor, the object sensor, the first electrically-operated valve, and the second electrically-operated valve. The switching device is configured such that if a water flow is detected in the sixth flow path by the flow sensor, then each of the first electrically-operated valve and the second electrically-operated valve is retained in an OFF state.

The invention, in another form thereof, is directed to a faucet assembly. The faucet assembly includes a spout defining a primary flow path. A first valve assembly provides at least one of water flow regulation and water temperature regulation. The first valve assembly has a first electrically-operated valve, a second electrically-operated valve, a first input port, a second input port, and an output port. The first electrically-operated valve is coupled between the first input port and the output port and the second electrically-operated valve is coupled between the second input port and the output port. A first water supply path is coupled to the first input port of the first valve assembly. A second water supply path is coupled to the second input port of the first valve assembly. A third flow path is coupled between the output port of the first valve assembly and the spout. A first sensor array has a first plurality of sensors located in a predetermined pattern. The first sensor array provides a first sensor array output signal corresponding to a position of an object in relation to the respective locations of the first plurality of sensors in the first sensor array. A control module is communicatively coupled to the first electrically-operated valve, the second electrically-operated valve, and the first sensor array. The control module controls the first electrically-operated valve and the second electrically-operated valve to open by an amount as determined from the first sensor array output signal.

The invention, in another form thereof, is directed to an electronic controller for a faucet. The electronic controller includes a body, and a first sensor array having a first plurality of sensors located in a predetermined pattern on the body. The first sensor array provides a first sensor array output signal corresponding to a position of an object in relation to the respective locations of the first plurality of sensors in the first sensor array.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic illustration of a faucet in accordance with an embodiment of the present invention.

FIG. 2A is a diagrammatic illustration of a faucet in accordance with another embodiment of the present invention.

FIG. 2B is a perspective view of the faucet of FIG. 2A.

FIG. 3 is a diagrammatic illustration of a faucet in accordance with another embodiment of the present invention.

FIG. 4 is a diagrammatic illustration of a faucet in accordance with another embodiment of the present invention.

FIG. 5 is a diagrammatic illustration of a faucet in accordance with another embodiment of the present invention.

FIG. 6 is a diagrammatic illustration of a faucet in accordance with another embodiment of the present invention.

FIG. 7 is a diagrammatic illustration of a faucet assembly in accordance with another embodiment of the present invention.

FIG. 8 is a diagrammatic illustration of a faucet assembly in accordance with another embodiment of the present invention.

FIG. 9 is a diagrammatic illustration of a faucet assembly in accordance with another embodiment of the present invention.

FIG. 10 is a diagrammatic illustration of a faucet assembly in accordance with another embodiment of the present invention.

Corresponding reference characters indicate corresponding parts throughout the several views. The exemplifications set out herein illustrate embodiments of the invention, and such exemplifications are not to be construed as limiting the scope of the invention in any manner.

### DESCRIPTION OF THE PREFERRED EMBODIMENT

In the several embodiments described below, certain terms are used for convenience, and are defined as follows. As used herein, the term “flow path” and variations thereof, refers to a device for directing a fluid flow, and may be, for example, a rigid pipe, flexible conduit, or a molded or machined passageway. The terms “coupled to” and “connected to”, and variations thereof, may be used to refer to either of a direct connection of two or more components, or an indirect connection of two or more components via one or more intervening devices. The term “communications link” refers to either wired or wireless electrical connections, or a combination thereof, between two or more devices. The term “communicatively coupled” refers to wired or wireless coupling, or a combination thereof, between two or more devices over a communications link to facilitate communication between the two or more devices.

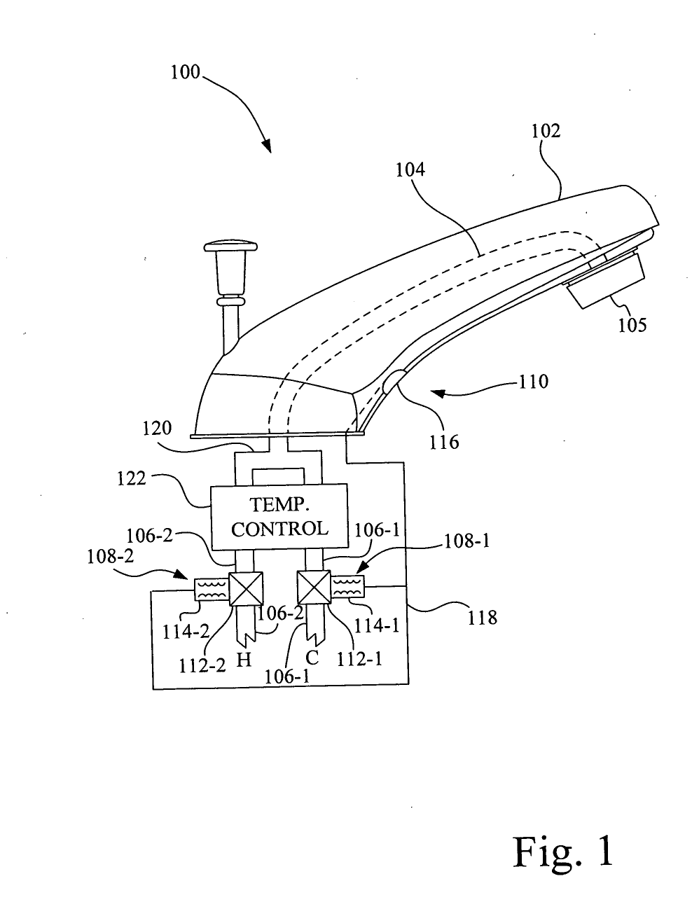

Referring now to the drawings and particularly to FIG. 1, there is shown a faucet 100 in accordance with another embodiment of the present invention. Faucet 100 includes a spout 102 defining a primary flow path 104 for carrying a stream of water. The stream of water exits primary flow path 104 at nozzle 105.

Faucet 100 also includes a water flow path 106-1, a water flow path 106-2, a solenoid-operated valve 108-1, a solenoid-operated valve 108-2, and a control device 110.

Water flow path 106-1 may be, for example, one or more pipes forming a cold water (C) flow path that is coupled to primary flow path 104 of spout 102. Water flow path 106-2 may be, for example, one or more pipes forming a hot water (H) flow path that is coupled to primary flow path 104 of spout 102. In this embodiment the coupling may be made, for example, via a T-connection pipe 120 and a temperature control 122. In other words, temperature control 122 is coupled into each of water flow path 106-1 and water flow path 106-2 and the water output of temperature control 122 is combined by T-connection pipe 120. Those skilled in the art will recognize that T-connection pipe 120 may be incorporated into temperature control 122, if desired. Temperature control 122 may, for example, sense water temperature and adjust the water temperature to a desired, e.g., pre-selected, temperature.

Solenoid-operated valve 108-1 is coupled into water flow path 106-1 to control a water flow through water flow path 106-1. Solenoid-operated valve 108-2 is coupled into water flow path 106-2 to control a water flow through water flow path 106-2. In turn, each of solenoid-operated valves 108-1 and 108-2 control a water flow through primary flow path 104 of spout 102.

Solenoid-operated valve 108-1 includes a valve 112-1 and a solenoid 114-1. Solenoid 114-1 is attached to valve 112-1 to move valve 112-1 between an ON state (e.g., the valve is open) and an OFF state (e.g., the valve is closed). In this embodiment, for example, valve 112-1 is operated in an ON state by application of an electrical signal to solenoid 114-1. Solenoid-operated valve 108-1 may be arranged, for example, for full ON/full OFF operation.

Likewise, solenoid-operated valve 108-2 includes a valve 112-2 and a solenoid 114-2. Solenoid 114-2 is attached to valve 112-2 to move valve 112-2 between an ON state (e.g., the valve is open) and an OFF state (e.g., the valve is closed). In this embodiment, for example, valve 112-2 is operated in an ON state by application of an electrical signal to solenoid 114-2. Solenoid-operated valve 108-2 may be arranged, for example, for full ON/full OFF operation.

Control device 110 is communicatively coupled to each of solenoid-operated valves 108-1 and 108-2. Control device 110 includes a sensor 116 coupled via a communications link 118 to solenoid 114-1 of solenoid-operated valve 108-1 and to solenoid 114-2 of solenoid-operated valve 108-2. Communications link 118 may be, for example, a wired or wireless connection. Sensor 116 may be, for example, an infrared control sensor or a radar control sensor.

Temperature control 122 is coupled into each of water flow path 106-1 and water flow path 106-2 to regulate a water temperature in primary flow path 104 of spout 102. Temperature control 122 may be, for example, a valve assembly that is manually adjustable to select the desired proportions of hot water (H) and cold water (C) that combine to form the water flow in primary flow path 104 of spout 102.

During operation, sensor 116 sends a signal via communications link 118 to each of solenoid 114-1 of solenoid-operated valve 108-1 and to solenoid 114-2 of solenoid-operated valve 108-2 to place each of solenoid-operated valves 108-1 and 108-2 in an ON state when sensor 116 detects the presence of an object, e.g., the presence of a user's hand. The cold and hot water then flows, respectively, through valves 112-1 and 112-2, and is delivered to temperature control 122, where the proportions of hot and cold water are selected for delivery to T-connection pipe 120 to form a combined water stream in primary flow path 104 of spout 102 at the desired temperature.

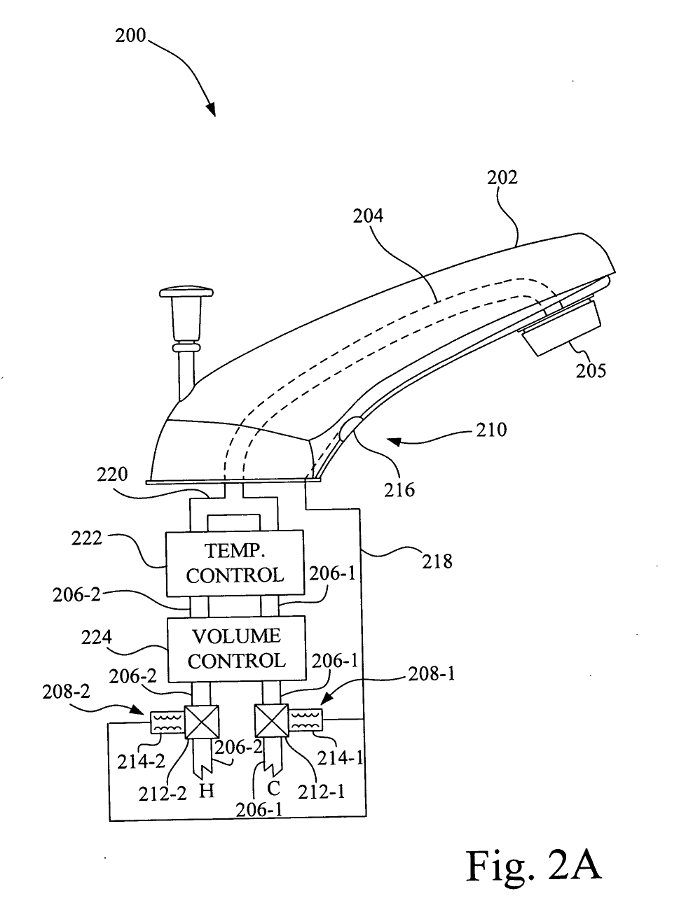

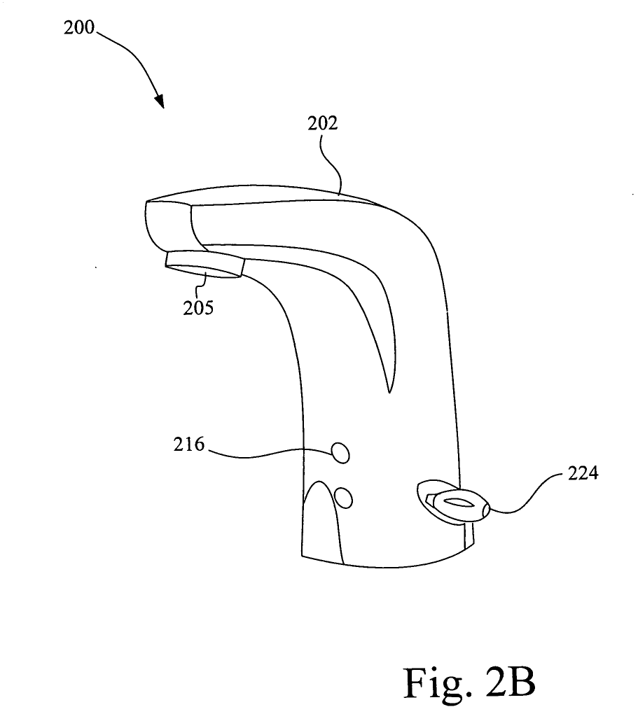

Referring now to FIGS. 2A and 2B, there is shown a faucet 200 in accordance with another embodiment of the present invention. Faucet 200 includes a spout 202 defining a primary flow path 204 for carrying a stream of water. Primary flow path 204 may be, for example, a rigid pipe, flexible conduit, or a molded or machined passageway. The stream of water exits primary flow path 204 at nozzle 205.

Faucet 200 also includes a water flow path 206-1, a water flow path 206-2, a solenoid-operated valve 208-1, a solenoid-operated valve 208-2, and a control device 210.

Water flow path 206-1 may be, for example, one or more pipes forming a cold water (C) flow path that is coupled to primary flow path 204 of spout 202. Water flow path 206-2 may be, for example, one or more pipes forming a hot water (H) flow path that is coupled to primary flow path 204 of spout 202. In this embodiment the coupling may be made, for example, via a T-connection pipe 220, a temperature control 222, and a fluid volume control 224. In other words, fluid volume control 224 is coupled into each of water flow path 206-1 and water flow path 206-2, and in turn is coupled to temperature control 222. Temperature control 222 is coupled into each of water flow path 206-1 and water flow path 206-2 and the water output of temperature control 222 is combined by T-connection pipe 220. Those skilled in the art will recognize that T-connection pipe 220 may be incorporated into temperature control 222, if desired. Also, for example, T-connection pipe 220, temperature control 222, and fluid volume control 224 may be incorporated into a single unit.

Solenoid-operated valve 208-1 is coupled into water flow path 206-1 to control a water flow through water flow path 206-1. Solenoid-operated valve 208-2 is coupled into water flow path 206-2 to control a water flow through water flow path 206-2. In turn, each of solenoid-operated valves 208-1 and 208-2 control a water flow through primary flow path 204 of spout 202.

Solenoid-operated valve 208-1 includes a valve 212-1 and a solenoid 214-1. Solenoid 214-1 is attached to valve 212-1 to move valve 212-1 between an ON state (e.g., the valve is open) and an OFF state (e.g., the valve is closed). In this embodiment, for example, valve 212-1 is operated in an ON state by application of an electrical signal to solenoid 214-1. Solenoid-operated valve 208-1 may be arranged, for example, for full ON/full OFF operation.

Likewise, solenoid-operated valve 208-2 includes a valve 212-2 and a solenoid 214-2. Solenoid 214-2 is attached to valve 212-2 to move valve 212-2 between an ON state (e.g., the valve is open) and an OFF state (e.g., the valve is closed). In this embodiment, for example, valve 212-2 is operated in an ON state by application of an electrical signal to solenoid 214-2. Solenoid-operated valve 208-2 may be arranged, for example, for full ON/full OFF operation.

Control device 210 is communicatively coupled to each of solenoid-operated valves 208-1 and 208-2. Control device 210 includes a sensor 216 coupled via a communications link 218 to solenoid 214-1 of solenoid-operated valve 208-1 and to solenoid 214-2 of solenoid-operated valve 208-2. Communications link 218 may be, for example, a wired or wireless connection. Sensor 216 may be, for example, an infrared control sensor or a radar control sensor.

Temperature control 222 is coupled into each of water flow path 206-1 and water flow path 206-2 to regulate a water temperature in primary flow path 204 of spout 202. Temperature control 222 may be, for example, a valve assembly that is manually adjustable to select the desired proportions of hot water (H) and cold water (C) that combine to form the water flow in primary flow path 204 of spout 202.

Fluid volume control 224 is coupled into each of water flow path 206-1 and water flow path 206-2 to regulate a volume of water in primary flow path 204 of spout 202 when at least one of solenoid-operated valve 208-1 and solenoid-operated valve 208-2 is in the ON state. Fluid volume control 224 may be, for example, a flow control valve assembly that has a rotatable handle that is manually adjustable, as illustrated, for example, in FIG. 2B, to select the desired flow rate of the combined flow of hot water (H) and cold water (C) in primary flow path 204 of spout 202.

During operation, sensor 216 sends a signal via communications link 218 to each of solenoid 214-1 of solenoid-operated valve 208-1 and to solenoid 214-2 of solenoid-operated valve 208-2 to place each of solenoid-operated valves 208-1 and 208-2 in an ON state when sensor 216 detects the presence of an object, e.g., the presence of a user's hand. The cold and hot water then flows, respectively, through valves 212-1 and 212-2, and is delivered to fluid volume control 224 to regulate a volume of water in primary flow path 204 of spout 202. The volume controlled flows of hot and cold water exit fluid volume control 224 and are delivered to temperature control 222. At temperature control 222, proportions of hot and cold water are selected for delivery to T-connection pipe 220 to form a combined water stream in primary flow path 204 of spout 202 at the desired temperature.

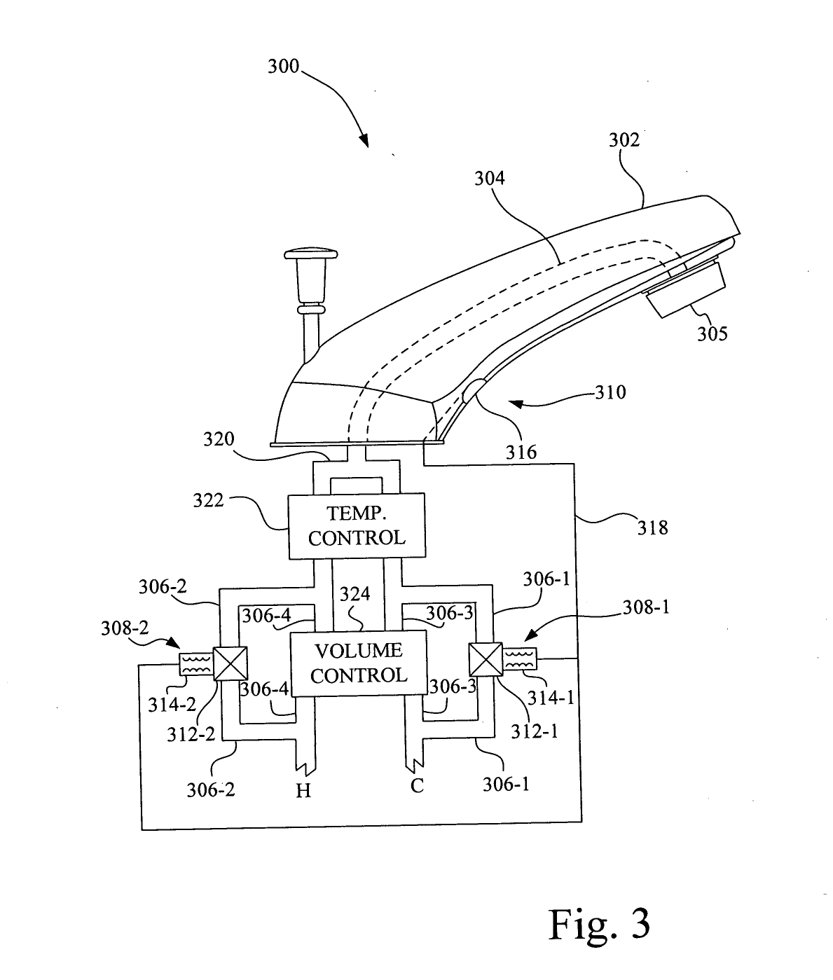

Referring now to FIG. 3, there is shown a faucet 300 in accordance with another embodiment of the present invention. Faucet 300 includes a spout 302 defining a primary flow path 304 for carrying a stream of water. Primary flow path 304 may be, for example, a rigid pipe, flexible conduit, or a molded or machined passageway. The stream of water exits primary flow path 304 at nozzle 305.

Faucet 300 also includes a water flow path 306-1, a water flow path 306-2, an auxiliary flow path 306-3, an auxiliary flow path 306-4, a solenoid-operated valve 308-1, a solenoid-operated valve 308-2, and a control device 310.

Each of water flow path 306-1 and auxiliary flow path 306-3 may be, for example, one or more pipes forming a cold water (C) flow path that is coupled to primary flow path 304 of spout 302. Each of water flow path 306-2 and auxiliary flow path 306-4 may be, for example, one or more pipes forming a hot water (H) flow path that is coupled to primary flow path 304 of spout 302. Auxiliary flow path 306-3 is connected in parallel with solenoid-operated valve 308-1. Auxiliary flow path 306-4 is connected in parallel with solenoid-operated valve 308-2. Here, the term “parallel” is not used in a geometric sense, but rather, is used in a component connectivity sense as commonly used in describing fluidic and electric circuits.

In this embodiment the coupling of water flow path 306-1, water flow path 306-2, auxiliary flow path 306-3, and auxiliary flow path 306-4 to primary flow path 304 of spout 302 may be made, for example, via a T-connection pipe 320 and temperature control 322.

Fluid volume control 324 is coupled into each of auxiliary flow path 306-3 and auxiliary flow path 306-4. Temperature control 322 is coupled to each of water flow path 306-1, water flow path 306-2, auxiliary flow path 306-3, and auxiliary flow path 306-4, and the water output of temperature control 322 is combined by T-connection pipe 320. Those skilled in the art will recognize that T-connection pipe 320 may be incorporated into temperature control 322, if desired. Also, for example, solenoid-operated valve 308-1, solenoid-operated valve 308-2, T-connection pipe 320, temperature control 322, fluid volume control 324, auxiliary flow path 306-3 and auxiliary flow path 306-4 may be incorporated into a single unit.

Solenoid-operated valve 308-1 is coupled into water flow path 306-1 to control a water flow through water flow path 306-1. Solenoid-operated valve 308-2 is coupled into water flow path 306-2 to control a water flow through water flow path 306-2. In turn, each of solenoid-operated valves 308-1 and 308-2 may control a water flow through primary flow path 304 of spout 302.

Solenoid-operated valve 308-1 includes a valve 312-1 and a solenoid 314-1. Solenoid 314-1 is attached to valve 312-1 to move valve 312-1 between an ON state (e.g., the valve is open) and an OFF state (e.g., the valve is closed). In this embodiment, for example, valve 312-1 is operated in an ON state by application of an electrical signal to solenoid 314-1. Solenoid-operated valve 308-1 may be arranged, for example, for full ON/full OFF operation.

Likewise, solenoid-operated valve 308-2 includes a valve 312-2 and a solenoid 314-2. Solenoid 314-2 is attached to valve 312-2 to move valve 312-2 between an ON state (e.g., the valve is open) and an OFF state (e.g., the valve is closed). In this embodiment, for example, valve 312-2 is operated in an ON state by application of an electrical signal to solenoid 314-2. Solenoid-operated valve 308-2 may be arranged, for example, for full ON/full OFF operation.

Control device 310 is communicatively coupled to each of solenoid-operated valves 308-1 and 308-2. Control device 310 includes a sensor 316 coupled via a communications link 318 to solenoid 314-1 of solenoid-operated valve 308-1 and to solenoid 314-2 of solenoid-operated valve 308-2. Communications link 318 may be, for example, a wired or wireless connection. Sensor 316 may be, for example, an infrared control sensor or a radar control sensor.

Temperature control 322 is coupled into each of water flow path 306-1, water flow path 306-2, auxiliary flow path 306-3 and auxiliary flow path 306-4 to regulate a water temperature in primary flow path 304 of spout 302. Temperature control 322 may be, for example, a valve assembly that is manually adjustable to select the desired proportions of hot water (H) and cold water (C) that combine to form the water flow in primary flow path 304 of spout 302.

Fluid volume control 324 is coupled into each of auxiliary flow path 306-3 and auxiliary flow path 306-4 to regulate a volume of water in primary flow path 304 of spout 302 when solenoid-operated valve 308-1 and solenoid-operated valve 308-2 are in the OFF state. Fluid volume control 324 may be, for example, a flow control valve assembly that is manually adjustable to select the desired flow rate of the combined flow of hot water (H) and cold water (C) in primary flow path 304 of spout 302.

Fluid volume control 324 provides, when in an ON state, a manual bypass of solenoid-operated valve 308-1 when solenoid-operated valve 308-1 is in an OFF state, and provides a manual bypass of solenoid-operated valve 308-2 when solenoid-operated valve 308-2 is in an OFF state. Conversely, when each of solenoid-operated valve 308-1 and solenoid-operated valve 308-2 is in an ON state, then fluid volume control 324 is in effect bypassed.

During operation, sensor 316 sends a signal via communications link 318 to each of solenoid 314-1 of solenoid-operated valve 308-1 and to solenoid 314-2 of solenoid-operated valve 308-2 to place each of solenoid-operated valves 308-1 and 308-2 in an ON state when sensor 316 detects the presence of an object, e.g., the presence of a user's hand. The cold and hot water then flows, respectively, through valves 312-1 and 312-2, and is delivered to temperature control 322. Alternatively, fluid volume control 324 may manually regulate a volume of water in primary flow path 304 of spout 302 when each of solenoid-operated valves 308-1 and 308-2 in an OFF state. The volume controlled flows of hot and cold water exit fluid volume control 324 and are delivered to temperature control 322.

At temperature control 322, proportions of hot and cold water are selected for delivery to T-connection pipe 320 to form a combined water stream in primary flow path 304 of spout 302 at the desired temperature.

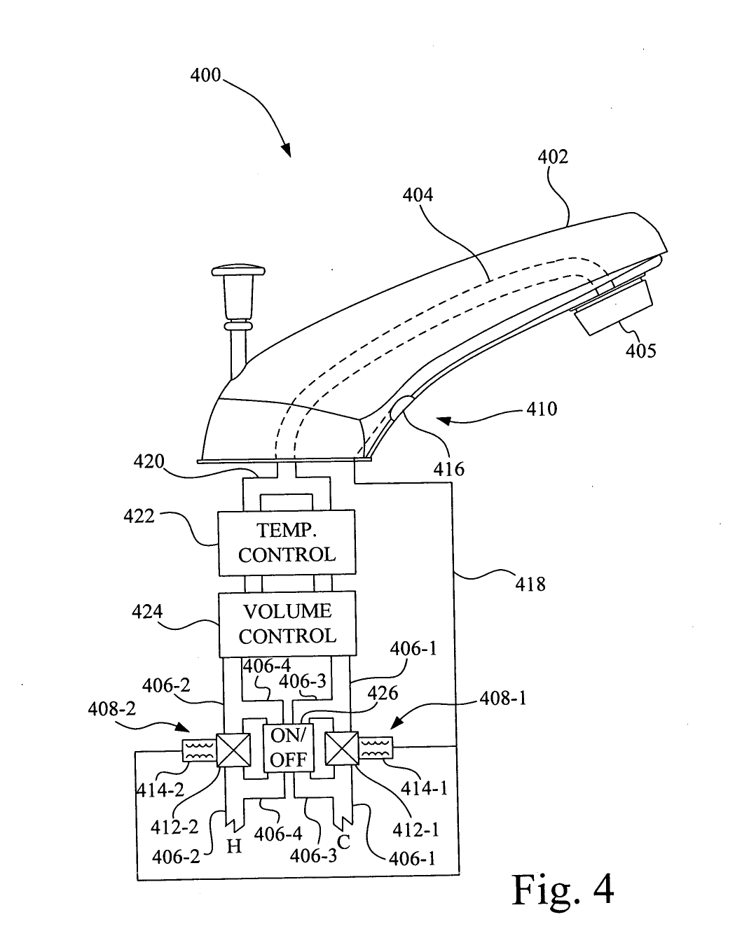

Referring now to FIG. 4, there is shown a faucet 400 in accordance with another embodiment of the present invention. Faucet 400 includes a spout 402 defining a primary flow path 404 for carrying a stream of water. Primary flow path 404 may be, for example, a rigid pipe, flexible conduit, or a molded or machined passageway. The stream of water exits primary flow path 404 at nozzle 405.

Faucet 400 also includes a water flow path 406-1, a water flow path 406-2, an auxiliary flow path 406-3, an auxiliary flow path 406-4, a solenoid-operated valve 408-1, a solenoid-operated valve 408-2, and a control device 410.

Each of water flow path 406-1 and auxiliary flow path 406-3 may be, for example, one or more pipes forming a cold water (C) flow path that is coupled to primary flow path 404 of spout 402. Each of water flow path 406-2 and auxiliary flow path 406-4 may be, for example, one or more pipes forming a hot water (H) flow path that is coupled to primary flow path 404 of spout 402. Auxiliary flow path 406-3 is connected in parallel with solenoid-operated valve 408-1. Auxiliary flow path 406-4 is connected in parallel with solenoid-operated valve 408-2. Here, the term “parallel” is not used in a geometric sense, but rather, is used in a component connectivity sense as commonly used in describing fluidic and electric circuits.

In this embodiment the coupling of water flow path 406-1, water flow path 406-2, auxiliary flow path 406-3, and auxiliary flow path 406-4 to primary flow path 404 of spout 402 may be made, for example, via a T-connection pipe 420, a temperature control 422, and a fluid volume control 424. An ON/OFF valve assembly 426 is coupled into each of auxiliary flow path 406-3 and auxiliary flow path 406-4.

Temperature control 422 and fluid volume control 424 are coupled to each of water flow path 406-1, water flow path 406-2, auxiliary flow path 406-3, and auxiliary flow path 406-4, and the water output of temperature control 422 is combined by T-connection pipe 420. Those skilled in the art will recognize that T-connection pipe 420 may be incorporated into temperature control 422, if desired. Also, for example, T-connection pipe 420, temperature control 422, and fluid volume control 424 may be incorporated into a single unit.

Solenoid-operated valve 408-1 is coupled into water flow path 406-1 to control a water flow through water flow path 406-1. Solenoid-operated valve 408-2 is coupled into water flow path 406-2 to control a water flow through water flow path 406-2. In turn, each of solenoid-operated valves 408-1 and 408-2 may control a water flow through primary flow path 404 of spout 402.

Solenoid-operated valve 408-1 includes a valve 412-1 and a solenoid 414-1. Solenoid 414-1 is attached to valve 412-1 to move valve 412-1 between an ON state (e.g., the valve is open) and an OFF state (e.g., the valve is closed). In this embodiment, for example, valve 412-1 is operated in an ON state by application of an electrical signal to solenoid 414-1. Solenoid-operated valve 408-1 may be arranged, for example, for full ON/full OFF operation.

Likewise, solenoid-operated valve 408-2 includes a valve 412-2 and a solenoid 414-2. Solenoid 414-2 is attached to valve 412-2 to move valve 412-2 between an ON state (e.g., the valve is open) and an OFF state (e.g., the valve is closed). In this embodiment, for example, valve 412-2 is operated in an ON state by application of an electrical signal to solenoid 414-2. Solenoid-operated valve 408-2 may be arranged, for example, for full ON/full OFF operation.

Control device 410 is communicatively coupled to each of solenoid-operated valves 408-1 and 408-2. Control device 410 includes a sensor 416 coupled via a communications link 418 to solenoid 414-1 of solenoid-operated valve 408-1 and to solenoid 414-2 of solenoid-operated valve 408-2. Communications link 418 may be, for example, a wired or wireless connection. Sensor 416 may be, for example, an infrared control sensor or a radar control sensor.

Temperature control 422 is coupled to each of water flow path 406-1, water flow path 406-2, auxiliary flow path 406-3 and auxiliary flow path 406-4 to regulate a water temperature in primary flow path 404 of spout 402. Temperature control 422 may be, for example, a valve assembly that is manually adjustable to select the desired proportions of hot water (H) and cold water (C) that combine to form the water flow in primary flow path 404 of spout 402 at the desired temperature.

Fluid volume control 424 is coupled to each of water flow path 406-1, water flow path 406-2, auxiliary flow path 406-3 and auxiliary flow path 406-4 to regulate a volume of water in primary flow path 404 of spout 402 when at least one of solenoid-operated valve 408-1 and solenoid-operated valve 408-2 is in the ON state, and/or when ON/OFF valve assembly 426 is in an ON state. Fluid volume control 424 may be, for example, a flow control valve assembly that is manually adjustable to select the desired flow rate of the combined flow of hot water (H) and cold water (C) in primary flow path 404 of spout 402.

ON/OFF valve assembly 426 is coupled into each of auxiliary flow path 406-3 and auxiliary flow path 406-4 to regulate in an ON/OFF manner a volume of water in primary flow path 404 of spout 402 when solenoid-operated valve 408-1 and solenoid-operated valve 408-2 are in the OFF state. ON/OFF valve assembly 426 may be, for example, a two position (ON/OFF) valve assembly that is manually or electrically actuated.

ON/OFF valve assembly 426 provides, when in an ON state, a bypass of solenoid-operated valve 408-1 when solenoid-operated valve 408-1 is in an OFF state, and provides a bypass of solenoid-operated valve 408-2 when solenoid-operated valve 408-2 is in an OFF state. Conversely, when each of solenoid-operated valve 408-1 and solenoid-operated valve 408-1 is in an ON state, then ON/OFF valve assembly, when in an OFF state, is bypassed.

During operation, sensor 416 sends a signal via communications link 418 to each of solenoid 414-1 of solenoid-operated valve 408-1 and to solenoid 414-2 of solenoid-operated valve 408-2 to place each of solenoid-operated valves 408-1 and 408-2 in an ON state when sensor 416 detects the presence of an object, e.g., the presence of a user's hand. The cold and hot water then flows, respectively, through valves 412-1 and 412-2 and is delivered to fluid volume control 424 path to regulate a volume of water in primary flow path 404 of spout 402. The volume controlled flows of hot and cold water exit fluid volume control 424 and are delivered to temperature control 422. At temperature control 422, proportions of hot and cold water are selected for delivery as a combined stream via T-connection pipe 420 to primary flow path 404 of spout 402 at the desired temperature.

Alternatively, ON/OFF valve assembly 426 may be placed in an ON state, either under manual or electrical control. The cold and hot water then flows, respectively, through ON/OFF valve assembly 426, and is delivered to fluid volume control 424 path to regulate a volume of water in primary flow path 404 of spout 402. The volume controlled flows of hot and cold water exit fluid volume control 424 and are delivered to temperature control 422. At temperature control 422, proportions of hot and cold water are selected for delivery to T-connection pipe 420 to form a combined water stream in primary flow path 404 of spout 402 at the desired temperature.

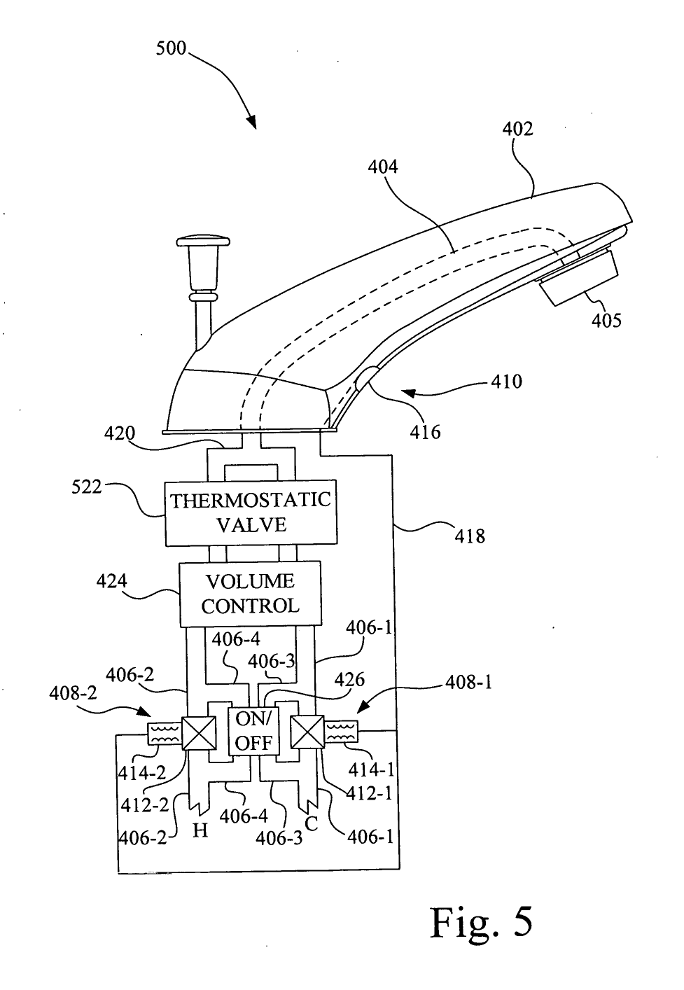

Referring now to FIG. 5, there is shown a faucet 500 in accordance with another embodiment of the present invention. Faucet 500 is substantially the same as faucet 400, with the exception that temperature control 422 is in the form of a thermostatic valve 522. Accordingly, for brevity, only the differences will be discussed here. Thermostatic valve 522 actively and automatically adjusts the temperature of the water flow delivered to primary flow path 404 of spout 402. Otherwise, the operation of faucet 500 is the same as that of faucet 400 described above.

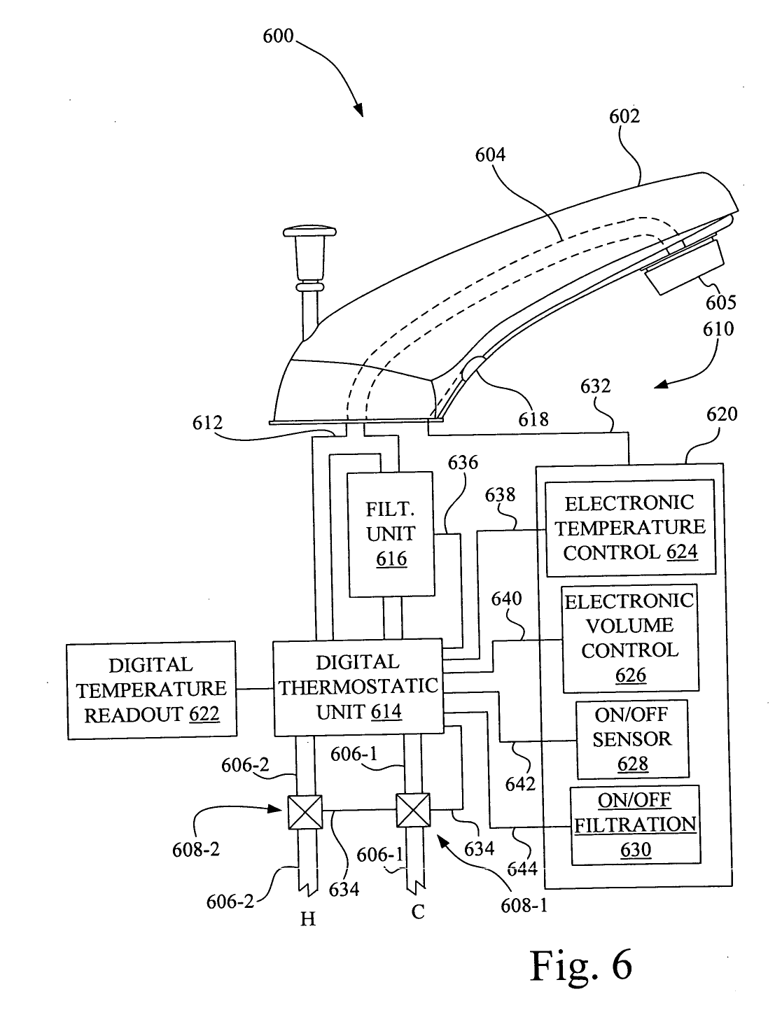

Referring now to FIG. 6, there is shown a faucet 600 in accordance with another embodiment of the present invention. Faucet 600 includes a spout 602 defining a primary flow path 604 for carrying a stream of water. Primary flow path 604 may be, for example, a rigid pipe, flexible conduit, or a molded or machined passageway. The stream of water exits primary flow path 604 at nozzle 605.

Faucet 600 also includes a water flow path 606-1, a water flow path 606-2, a electrically-operated valve 608-1, a electrically-operated valve 608-2, and a control device 610.

Water flow path 606-1 may be, for example, one or more pipes forming a cold water (C) flow path that is coupled to primary flow path 604 of spout 602. Water flow path 606-2 may be, for example, one or more pipes forming a hot water (H) flow path that is coupled to primary flow path 604 of spout 602. In this embodiment the coupling may be made, for example, via a T-connection pipe 612, a digital thermostatic unit 614, and a filtration unit 616. In other words, digital thermostatic unit 614 is coupled to each of water flow path 606-1 and water flow path 606-2, and the water output of digital thermostatic unit 614 is combined by T-connection pipe 612, with filtration unit 616 filtering the cold water (C). Those skilled in the art will recognize that T-connection pipe 612 and filtration unit 616 may be incorporated into digital thermostatic unit 614, if desired, to form a single unit.

Electrically-operated valve 608-1 is coupled into water flow path 606-1 to control a water flow through water flow path 606-1. Electrically-operated valve 608-2 is coupled into water flow path 606-2 to control a water flow through water flow path 606-2. In turn, each of electrically-operated valves 608-1 and 608-2 control a water flow through primary flow path 604 of spout 602. Each of electrically-operated valves 608-1 and 608-2 may be, for example, a motorized valve, wherein a rotation of a motor shaft results in an opening or closing of a valve based on the direction of shaft rotation.

In this embodiment, for example, electrically-operated valves 608-1 and 608-2 are operated in an ON state by application of an electrical signal. Electrically-operated valves 608-1 and 608-2 may be arranged, for example, wherein the ON state includes a variable range of flow volumes, and wherein the electric signal received from control device 610 individually operates electrically-operated valve 608-1 and electrically-operated valve 608-2 to regulate a volume of water delivered to primary flow path 604. Control device 610 is communicatively coupled to each of electrically-operated valves 608-1 and 608-2 via digital thermostatic unit 614.

Control device 610 includes a sensor 618, a control module 620, and a digital temperature readout display 622. Sensor 618 may be, for example, an infrared control sensor or a radar control sensor. Control module 620 includes an electronic temperature control 624, an electronic volume control 626, an ON/OFF switch 628 for sensor 618, and an ON/OFF switch 630 for filtration unit 616.

Sensor 618 is communicatively coupled to control module 620 via a communications link 632. Electrically-operated valves 608-1 and 608-2 are communicatively coupled to digital thermostatic unit 614 via communications link 634. Filtration unit 616 is communicatively coupled to digital thermostatic unit 614 via communications link 636. Electronic temperature control 624 is communicatively coupled to digital thermostatic unit 614 via communications link 638. Electronic volume control 626 is communicatively coupled to digital thermostatic unit 614 via communications link 640. ON/OFF switch 628 is communicatively coupled to digital thermostatic unit 614 via communications link 642. ON/OFF switch 630 is communicatively coupled to digital thermostatic unit 614 via communications link 644. Each of the communications links may be, for example, a wired or wireless connection.

Digital thermostatic unit 614 is coupled into each of water flow path 606-1 and water flow path 606-2 to regulate a water temperature in primary flow path 604 of spout 602 based on inputs received from electronic temperature control 624. Digital thermostatic unit 614 may be, for example, a valve assembly including a thermostatic valve that is electrically adjustable to select the desired proportions of hot water (H) and cold water (C) that combine to form the water flow in primary flow path 604 of spout 602.

During operation, when sensor 618 detects the presence of an object, e.g., the presence of a user's hand, sensor 618 sends a signal via communications link 632 to control module 620. If ON/OFF switch 628 is in the ON position, control module 620 transfers the signal to digital thermostatic unit 614, which in turn relays the signal to electrically-operated valves 608-1 and 608-2 to place each of electrically-operated valves 608-1 and 608-2 in an ON state. Based on the signal received from electronic volume control 626, a desired flow volume is regulated by electrically-operated valves 608-1 and 608-2. The cold and hot water then flows, respectively, at the specified volume through electrically-operated valves 608-1 and 608-2, and is delivered to digital thermostatic unit 614, where the proportions of hot and cold water output by digital thermostatic unit 614 are controlled based on inputs received from electronic temperature control 624 to control the temperature of the water flow in primary flow path 604 of spout 602.

If ON/OFF switch 630 is in the ON position, then filtration unit 616 will receive and filter the cold water received from digital thermostatic unit 614, and filtered cold water will be supplied to T-connection pipe 612. If ON/OFF switch 630 is in the OFF position, then the filtration provided by filtration unit 616 will be bypassed internally, and unfiltered cold water will be supplied to T-connection pipe 612. Thereafter, the hot and cold water flow provided via digital thermostatic unit 614 is supplied to primary flow path 604 of spout 602.

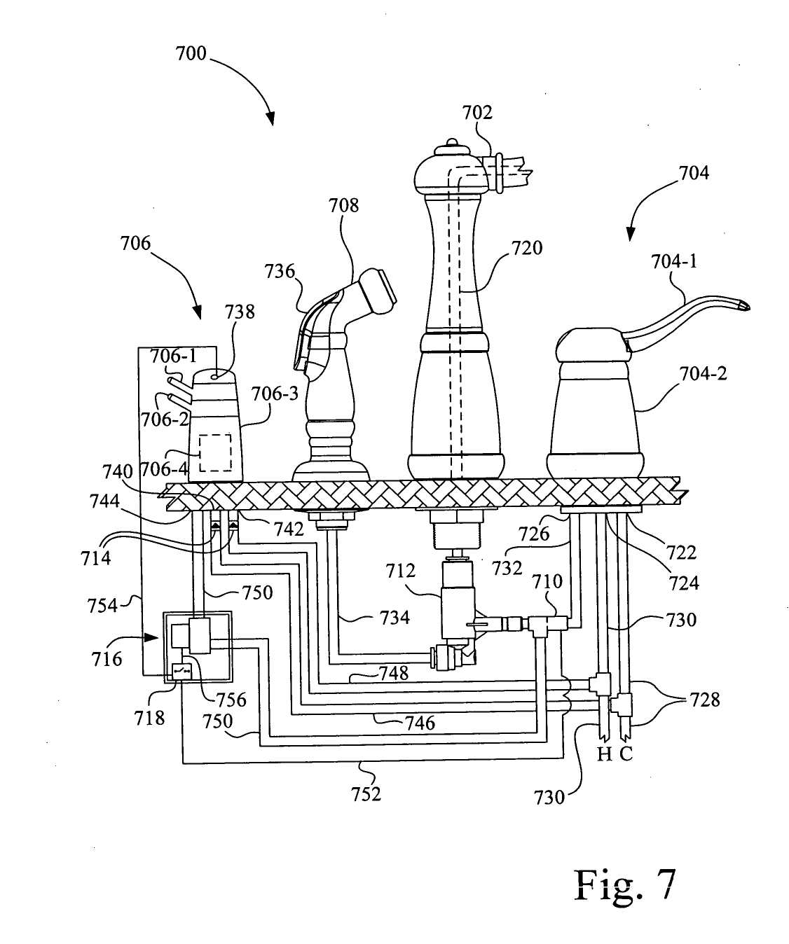

Referring now to FIG. 7, there is shown a faucet 700 in accordance with another embodiment of the present invention. Faucet assembly 700 includes a spout 702, a first valve assembly 704, a second valve assembly 706, a side spray 708, an electronic flow sensor 710, a diverter 712, a pair of check valves 714, an electrically-operated valve 716, and a switching device 718.

Spout 702 defines a primary flow path 720. First valve assembly 704 may be, for example, a standard manually operated valve having a single control handle 704-1 connected to a valve body 704-2 for providing water flow regulation and water temperature regulation. Valve assembly 704 has a first input port 722, a second input port 724 and a first output port 726. A first water supply path 728, e.g., one or more pipes for carrying cold water (C), is coupled to first input port 722 of valve assembly 704. A second water supply path 730, e.g., one or more pipes for carrying hot water (H), is coupled to second input port 724 of valve assembly 704. A third flow path 732 is coupled between output port 726 of valve assembly 704 and primary flow path 720 of spout 702 via electronic flow sensor 710 and diverter 712. Electronic flow sensor 710 is coupled into third flow path 732 to detect a water flow through first valve assembly 704. Diverter 712 is a pressure actuated valve that diverts a flow of water way from primary flow path 720 of spout 702 to a water flow path 734 coupled between diverter 712 and side spray 708 when an actuator 736 of side spray 708 is pressed.

Valve assembly 706 includes dual manual controls 706-1, 706-2 connected to a valve body 706-3 housing a through valve 706-4 for providing water flow regulation and/or water temperature regulation. Valve assembly 706 also includes an object sensor 738. Object sensor 738 may be, for example, an infrared control sensor or a radar control sensor, and is used to detect a presence of an object, such as a human hand in close proximity to valve assembly 706.

Valve assembly 706 has a third input port 740, a fourth input port 742 and a second output port 744. A fourth flow path 746 is coupled between third input port 740 and first water supply path 728. A fifth flow path 748 is coupled between fourth input port 742 and second water supply path 730. A sixth flow path 750 is coupled between second output port 744 of second valve assembly 706 and primary flow path 720 of spout 702 via electrically-operated valve 716 and diverter 712. The pair of check valves 714 is coupled into water flow paths 746 and 748 to prevent a backflow through second valve assembly 706.

Electrically-operated valve 716 is coupled into sixth flow path 750 to control a water flow through second valve assembly 706. Electrically-operated valve 716 may be, for example, one of a solenoid operated valve and a motor-operated valve.

Switching device 718 may be, for example, formed by a printed circuit board having discrete electronic components, or electromechanical relays or switches, or may be a programmable device. Switching device 718 is communicatively coupled to electronic flow sensor 710, object sensor 738, and electrically-operated valve 716 via communication links 752, 754, and 756, respectively.

Switching device 718 is configured such that if a water flow is detected by electronic flow sensor 710 in third flow path 732, i.e., a water flow through first valve assembly 704, then electrically-operated valve 716 is retained in an OFF state. For example, switching device 718 may be configured such that if a water flow is detected in third flow path 732 by electronic flow sensor 710, then electrically-operated valve 716 is disabled. As another example, switching device 718 may be configured such that if a water flow is detected in third flow path 732 by electronic flow sensor 710, then object sensor 738 is electrically disengaged from electrically-operated valve 716.

Also, switching device 718 is configured such that if no water flow is detected in third flow path 732 by electronic flow sensor 710, then electrically-operated valve 716 is enabled to operate in accordance with a detection signal supplied by object sensor 738, wherein electrically-operated valve 716 is placed in an ON state when the detection signal is received from object sensor 738 by switching device 718.

In the embodiment of FIG. 7, certain components were shown as separate devices for ease of discussion. However, those skilled in the art will recognize that two or more of the devices may be incorporated into a unitary device, if desired. For example, it is contemplated that second valve assembly 706, electrically-operated valve 716 and switching device 718 may be combined as an above-the-countertop unitary temperature/flow volume regulator valve assembly.

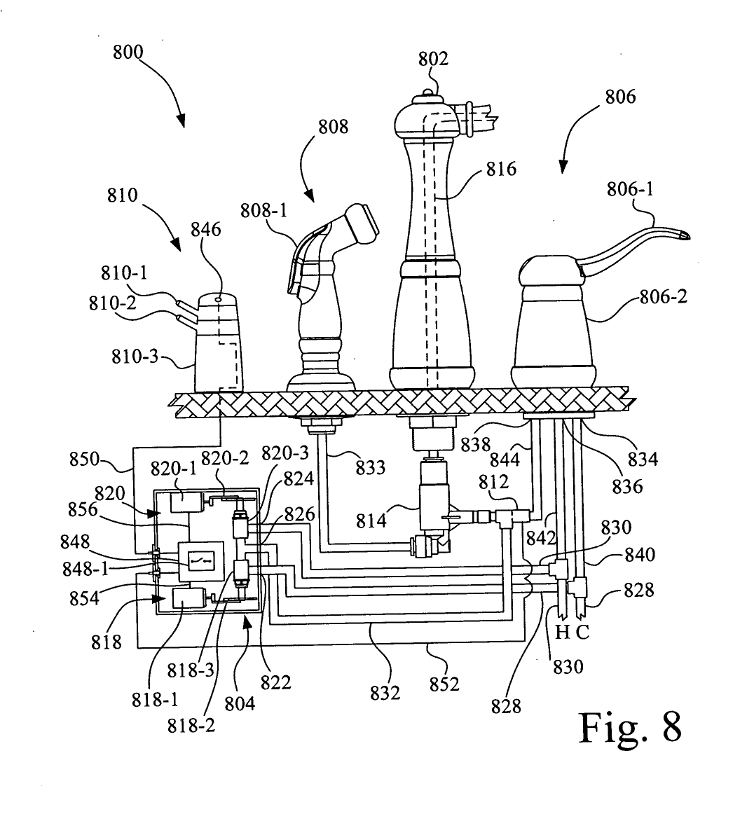

Referring to FIG. 8, there is shown a faucet assembly 800 in accordance with another embodiment of the present invention. Faucet assembly 800 includes a spout 802, a first valve assembly 804, a second valve assembly 806, a side spray 808, a controller 810, an electronic flow sensor 812, and a diverter 814. Spout 802 defines a primary flow path 816.

First valve assembly 804 is configured to provide water flow regulation and/or water temperature regulation. Valve assembly 804 has a first electrically-operated valve 818, a second electrically-operated valve 820, a first input port 822, a second input port 824, and a first output port 826. First electrically-operated valve 818 is coupled between first input port 822 and first output port 826 and second electrically-operated valve 820 is coupled between second input port 824 and first output port 826.

First electrically-operated valve 818 includes a motor 818-1 attached via a gear train 818-2 to a valve 818-3. Second electrically-operated valve 820 includes a motor 820-1 attached via gear train 820-2 to a valve 820-3. For example, motor 818-1 and gear train 818-2 facilitates a range of opening or closing of valve 818-3 from full closed to full open, the amount of which being selected by controller 810. Likewise, motor 820-1 and gear train 820-2 facilitates a range of opening or closing of valve 820-3 from full closed to full open, the amount of which being selected by controller 810.

A first water supply path 828, e.g., one or more pipes for carrying cold water (C), is coupled to first input port 822 of valve assembly 804. A second water supply path 830, e.g., one or more pipes for carrying hot water (H), is coupled to input port 824 of valve assembly 804. A third flow path 832 is coupled between first output port 826 of first valve assembly 804 and primary flow path 816 of spout 802 via diverter 814. Diverter 814 is a pressure actuated valve that diverts a flow of water way from primary flow path 816 of spout 802 to a water flow path 833 coupled between diverter 814 and side spray 808 when an actuator 808-1 of side spray 808 is pressed.

Second valve assembly 806 may be, for example, a standard manually operated valve having a single control handle 806-1 connected to a valve body 806-2 for providing water flow regulation and/or water temperature regulation. Valve assembly 806 has an third input port 834, a fourth input port 836 and a second output port 838. A fourth flow path 840 is coupled between third input port 834 of second valve assembly 806 and first water supply path 828. A fifth flow path 842 is coupled between fourth input port 836 and second water supply path 830. A sixth flow path 844 is coupled between second output port 838 of second valve assembly 806 and primary flow path 816 of spout 802 via electronic flow sensor 812 and diverter 814. Flow sensor 812 is coupled into sixth flow path 844 for detecting a water flow in sixth flow path 844, and in turn, for detecting a water flow through second valve assembly 806.

In this embodiment, controller 810 includes dual electrical, e.g., rheostat, controllers, e.g., a temperature controller 810-1 and a fluid volume controller 810-2 connected to a valve body 810-3 for providing an electrical signal for effecting water flow regulation and/or water temperature regulation via valve assembly 804. Controller 810 also includes an object sensor 846. Object sensor 846 may be, for example, an infrared control sensor or a radar control sensor, and is used to detect a presence of an object, such as a human hand in close proximity to controller 810.

Controller 810 is communicatively coupled to a control module 848 via a communication link 850. Control module 848 includes a switching device 848-1. Control module 848 and switching device 848-1 may be, for example, formed by a printed circuit board having discrete electronic components, or electromechanical relays or switches, or may be a programmable device. Switching device 848-1 is communicatively coupled to electronic flow sensor 812 via a communication link 852. Control module 848 and switching device 848-1 are also communicatively coupled to each of motors 818-1 and 820-1 via communication links 854 and 856, respectively.

Switching device 848-1 is configured such that if a water flow is detected in sixth flow path 844 by flow sensor 812, then each of first electrically-operated valve 818 and second electrically-operated valve 820 is retained in an OFF state. For example, switching device 848-1 may be configured such that if a water flow is detected in sixth flow path 844 by flow sensor 812, then each of first electrically-operated valve 818 and second electrically-operated valve 820 is disabled. As another example, switching device 848-1 may be configured such that if a water flow is detected in sixth flow path 844 by flow sensor 812, then object sensor 846 is electrically disengaged from each of first electrically-operated valve 818 and second electrically-operated valve 820.

Switching device 848-1 is also configured such that if no water flow is detected in sixth flow path 844 by flow sensor 812, then each of first electrically-operated valve 818 and second electrically-operated valve 820 is enabled to operate in accordance with a detection signal supplied by object sensor 846. For example, each of first electrically-operated valve 818 and second electrically-operated valve 820 may be placed in an ON state when the detection signal is received from object sensor 846 by switching device 848-1, and the degree of opening of valves 818-3 and/or 820-3 may be dependent on the signal received by control module 848 from temperature control 810-1 and fluid volume controller 810-2 of controller 810.

In the embodiment of FIG. 8, certain components were shown as separate devices for ease of discussion. However, those skilled in the art will recognize that two or more of the devices may be incorporated into a unitary device, if desired. For example, it is contemplated that controller 810, first valve assembly 804 and control module 848 may be combined as an above-the-countertop unitary temperature/flow volume regulator valve assembly.

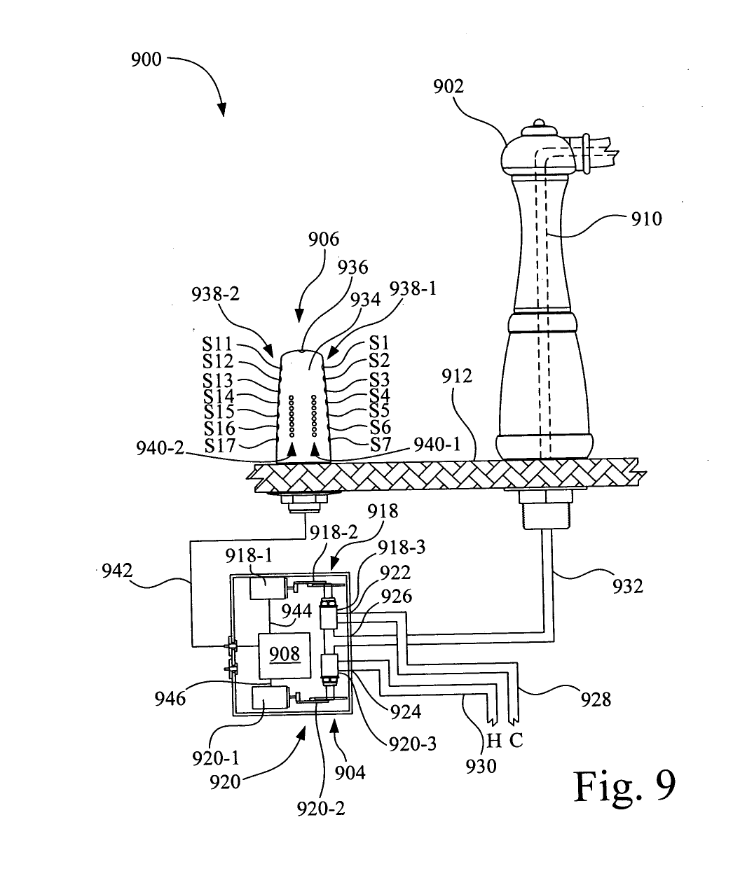

Referring to FIG. 9, there is shown a faucet assembly 900 in accordance with another embodiment of the present invention. Faucet assembly 900 includes a spout 902, a valve assembly 904, a controller 906, and a control module 908. Spout 902 defines a primary flow path 910 for carrying a flow of water. Each of spout 902 and controller 906 may be mounted to an upper surface of a countertop 912.

Valve assembly 904 is configured to provide water flow regulation and/or water temperature regulation. Valve assembly 904 has a first electrically-operated valve 918, a second electrically-operated valve 920, a first input port 922, a second input port 924, and an output port 926. First electrically-operated valve 918 is coupled between first input port 922 and output port 926 and second electrically-operated valve 920 is coupled between second input port 924 and output port 926.

First electrically-operated valve 918 includes a motor 918-1 attached via a gear train 918-2 to a valve 918-3. Second electrically-operated valve 920 includes a motor 920-1 attached via gear train 920-2 to a valve 920-3. For example, motor 918-1 and gear train 918-2 facilitates a range of opening or closing of valve 918-3 from full closed to full open, the amount of which being selected by controller 906. Likewise, motor 920-1 and gear train 920-2 facilitates a range of opening or closing of valve 920-3 from full closed to full open, the amount of which being selected by controller 906.

A first water supply path 928, e.g., one or more pipes for carrying cold water (C), is coupled to first input port 922 of valve assembly 904. A second water supply path 930, e.g., one or more pipes for carrying hot water (H), is coupled to second input port 924 of valve assembly 904. A third flow path 932 is coupled between output port 926 of valve assembly 904 and primary flow path 910 of spout 902.

In this embodiment, controller 906 includes a body 934, an object sensor 936, a first sensor array 938-1, a second sensor array 938-2, a first light emitting diode (LED) array 940-1, and a second LED array 940-2. Each of object sensor 936, first sensor array 938-1, second sensor array 938-2, first LED array 940-1, and second LED array 940-2 is mounted to body 934. Object sensor 936, and each sensor of the arrays of sensors 938-1 and 938-2, may be, for example, an infrared control sensor or a radar control sensor. Controller 906 is communicatively coupled to control module 908 via a communication link 942.

Object sensor 936 is communicatively coupled to control module 908 via communication link 942, and is used to detect a presence of an object, such as a human hand, in close proximity to the respective sensor. Object sensor 936 operates as an ON/OFF switch. When object sensor 936 detects the presence of an object, object sensor 936 sends a detection signal to control module 908.

First sensor array 938-1 has a first plurality of sensors, individually identified as sensors S1, S2, S3, S4, S5, S6, and S7 in this example, and is located on body 934 in a predetermined pattern, such as a vertical column. First sensor array 938-1 provides a first sensor array output signal corresponding to a position of an object in relation to the respective locations of the first plurality of sensors S1, S2, S3, S4, S5, S6, and S7 in first sensor array 938-1. First sensor array 938-1 supplies the first sensor array output signal to control module 908 via communication link 942.

For example, first sensor array 938-1 may be configured as a temperature controller, wherein sensor S1 represents cold water C and sensor S7 represents hot water H, with sensors S2, S3, S4, S5, S6 representing progressively warmer water temperatures, respectively. If, for example, medium warm water is desired, then a user may point a finger generally toward sensor S4. If the temperature is not as warm as desired, then the user may point a finger generally toward, including between, one or more of sensors S5, S6, and S7. Conversely, if the temperature is not as cool as desired, then the user may point a finger generally toward, including between, one or more of sensors S1, S2, and S3.

First LED array 940-1 has a first plurality of LEDs corresponding to the first plurality of sensors S1, S2, S3, S4, S5, S6, and S7 in first sensor array 938-1, and is located on body 934 in a predetermined pattern, such as a vertical column, to provide a visual indication of a water temperature selected via first sensor array 938-1. For example, the top LED may correspond to cold water and the bottom LED may correspond to hot water, with the intermediate LEDs representing progressively warmer water temperatures, respectively, from top to bottom. Also, LEDS of various colors may be used, e.g., a blue LED may represent cold water, a red LED may represent hot water, and various shades of green through yellow LEDs may represent progressively warmer water temperatures.

Second sensor array 938-2 has a second plurality of sensors, individually identified as sensors S11, S12, S13, S14, S15, S16, and S17 in this example, and is located on body 934 in a predetermined pattern, such as a vertical column. Second sensor array 938-2 provides a second sensor array output signal corresponding to a position of an object in relation to the respective locations of the second plurality of sensors S11, S12, S13, S14, S15, S16, and S17 in second sensor array 938-2. Second sensor array 938-2 supplies the second sensor array output signal to control module 908 via communication link 942.

For example, second sensor array 938-2 may be configured as a flow volume controller, wherein sensor S11 represents full OFF and sensor S17 represents full ON, with sensors S12, S13, S14, S15, S16 representing progressively higher flow volumes, respectively. If, for example, a medium stream of water is desired, then a user may point a finger generally toward sensor S14. If the flow volume is not as high as desired, then the user may point a finger generally toward, including between, one or more of sensors S15, S16, and S17. Conversely, if the flow volume is higher than desired, then the user may point a finger generally toward, including between, one or more of sensors S11, S12, and S13.

Second LED array 940-2 has a second plurality of LEDs corresponding to the second plurality of sensors S11, S12, S13, S14, S15, S16, and S17 in second sensor array 938-2, and is located on body 934 in a predetermined pattern, such as a vertical column, to provide a visual indication of a flow volume of a water flow selected via second sensor array 938-2. For example, the top LED may correspond to full OFF and the bottom LED may correspond to full ON, with the intermediate LEDs representing progressively higher flow volumes, respectively, from top to bottom. Also, LEDS of various colors may be used, e.g., a blue LED may represent full OFF, a red LED may represent full ON, and various shades of green through yellow LEDs may represent progressively higher flow volumes.

Controller 906 is communicatively coupled to control module 908 via communication link 942. Control module 908 may include a printed circuit board having discrete electronic components, or electromechanical relays or switches, or may be a programmable device, configured for processing the detection signal supplied by object sensor 936, the water temperature signal supplied by first sensor array 938-1 and the flow volume signal supplied by second sensor array 938-2. Controller 906 is communicatively coupled to each of motors 918-1 and 920-1 via communication links 944 and 946, respectively.

During operation, each of first electrically-operated valve 918 and second electrically-operated valve 920 may be placed in an ON state when the detection signal is received by control module 908 from object sensor 936, and the degree of opening of valves 918-3 and/or 920-3 may be dependent on the temperature signal received by control module 908 from a temperature control sensor array, e.g., first sensor array 938-1, of controller 906 and/or on the flow volume signal received by control module 908 from a flow volume sensor array, e.g., second sensor array 938-2, of controller 906.

In the embodiment of FIG. 9, those skilled in the art will recognize that the orientation, location and pattern of the various sensor arrays and LED arrays may be changed from that of the embodiments disclosed, if desired, without departing from the scope of this invention. Also, while the sensor arrays and LED arrays are described as providing sensing and indication from top-to-bottom, e.g., from cold-to-hot or full OFF-to-full ON, those skilled in the art will recognize that other sensing/indication schemes, e.g., from bottom-to-top, may be used, if desired.

In the embodiment of FIG. 9, certain components were shown as separate devices for ease of discussion. However, those skilled in the art will recognize that two or more of the devices may be incorporated into a unitary device, if desired. For example, it is contemplated that valve assembly 904, controller 906, and control module 908 may be combined as an above-the-countertop unitary temperature/flow volume regulator valve assembly.

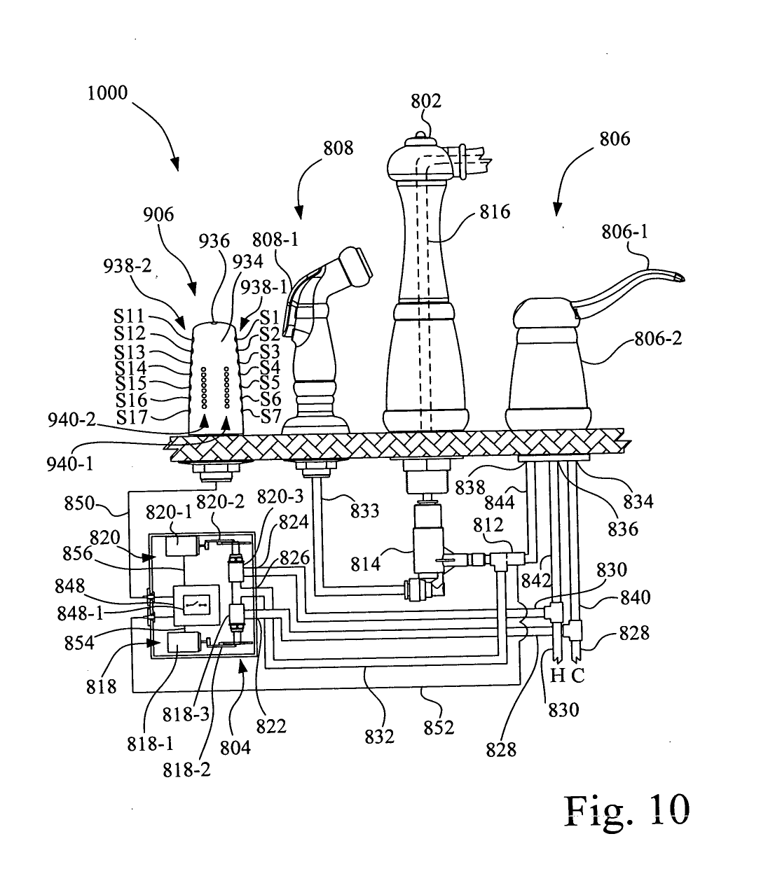

Referring to FIG. 10, there is shown a faucet assembly 1000 in accordance with another embodiment of the present invention. Faucet assembly 1000 includes spout 802, first valve assembly 804, second valve assembly 806, side spray 808, electronic flow sensor 812, diverter 814, control module 848, and controller 906. Spout 802 defines primary flow path 816.

First valve assembly 804 is configured to provide water flow regulation and/or water temperature regulation. Valve assembly 804 has a first electrically-operated valve 818, a second electrically-operated valve 820, a first input port 822, a second input port 824, and a first output port 826. First electrically-operated valve 818 is coupled between first input port 822 and first output port 826 and second electrically-operated valve 820 is coupled between second input port 824 and first output port 826.

First electrically-operated valve 818 includes a motor 818-1 attached via a gear train 818-2 to a valve 818-3. Second electrically-operated valve 820 includes a motor 820-1 attached via gear train 820-2 to a valve 820-3. For example, motor 818-1 and gear train 818-2 facilitates a range of opening or closing of valve 818-3 from full closed to full open, the amount of which being selected by controller 906 via control module 848. Likewise, motor 820-1 and gear train 820-2 facilitates a range of opening or closing of valve 820-3 from full closed to full open, the amount of which being selected by controller 906 via control module 848.

A first water supply path 828, e.g., one or more pipes for carrying cold water (C), is coupled to first input port 822 of valve assembly 804. A second water supply path 830, e.g., one or more pipes for carrying hot water (H), is coupled to second input port 824 of valve assembly 804. A third flow path 832 is coupled between first output port 826 of first valve assembly 804 and primary flow path 816 of spout 802 via diverter 814. Diverter 814 is a pressure actuated valve that diverts a flow of water way from primary flow path 816 of spout 802 to a water flow path 833 coupled between diverter 814 and side spray 808 when an actuator 808-1 of side spray 808 is pressed.

Second valve assembly 806 may be, for example, a standard manually operated valve having a single control handle 806-1 connected to a valve body 806-2 for providing water flow regulation and/or water temperature regulation. Valve assembly 806 has an third input port 834, a fourth input port 836 and a second output port 838. A fourth flow path 840 is coupled between third input port 834 of second valve assembly 806 and first water supply path 828. A fifth flow path 842 is coupled between fourth input port 836 and second water supply path 830. A sixth flow path 844 is coupled between second output port 838 of second valve assembly 806 and primary flow path 816 of spout 802 via electronic flow sensor 812 and diverter 814. Flow sensor 812 is coupled into sixth flow path 844 for detecting a water flow in sixth flow path 844, and in turn, for detecting a water flow through second valve assembly 806.

In this embodiment, controller 906 includes a body 934, an object sensor 936, a first sensor array 938-1, a second sensor array 938-2, a first light emitting diode (LED) array 940-1, and a second LED array 940-2. Each of object sensor 936, first sensor array 938-1, second sensor array 938-2, first LED array 940-1, and second LED array 940-2 is mounted to body 934. Object sensor 936, and each sensor of the arrays of sensors 938-1 and 938-2, may be, for example, an infrared control sensor or a radar control sensor. Controller 906 is communicatively coupled to control module 848 via a communication link 850.

Object sensor 936 is used to detect a presence of an object, such as a human hand, in close proximity to the respective sensor. Object sensor 936 operates as an ON/OFF switch. When object sensor 936 detects the presence of an object, object sensor 936 sends a detection signal to control module 848.

Control module 848 includes a switching device 848-1. Control module 848 and switching device 848-1 may be, for example, formed by a printed circuit board having discrete electronic components, or electromechanical relays or switches, or may be a programmable device. Switching device 848-1 is communicatively coupled to electronic flow sensor 812 via a communication link 852. Control module 848 and switching device 848-1 are also communicatively coupled to each of motors 818-1 and 820-1 via communication links 854 and 856, respectively.

Switching device 848-1 is configured such that if a water flow is detected in sixth flow path 844 by flow sensor 812, then each of first electrically-operated valve 818 and second electrically-operated valve 820 is retained in an OFF state. For example, switching device 848-1 may be configured such that if a water flow is detected in sixth flow path 844 by flow sensor 812, then each of first electrically-operated valve 818 and second electrically-operated valve 820 is disabled. As another example, switching device 848-1 may be configured such that if a water flow is detected in sixth flow path 844 by flow sensor 812, then object sensor 936 is electrically disengaged from each of first electrically-operated valve 818 and second electrically-operated valve 820.

Switching device 848-1 is also configured such that if no water flow is detected in sixth flow path 844 by flow sensor 812, then each of first electrically-operated valve 818 and second electrically-operated valve 820 is enabled to operate in accordance with a detection signal supplied by object sensor 936. For example, each of first electrically-operated valve 818 and second electrically-operated valve 820 may be placed in an ON state when the detection signal is received from object sensor 936 by switching device 848-1.

First sensor array 938-1 has a first plurality of sensors, individually identified as sensors S1, S2, S3, S4, S5, S6, and S7 in this example, and is located on body 934 in a predetermined pattern, such as a vertical column. First sensor array 938-1 provides a first sensor array output signal corresponding to a position of an object in relation to the respective locations of the first plurality of sensors S1, S2, S3, S4, S5, S6, and S7 in first sensor array 938-1. First sensor array 938-1 supplies the first sensor array output signal to control module 848 via communication link 850.

For example, first sensor array 938-1 may be configured as a temperature controller, wherein sensor S1 represents cold water C and sensor S7 represents hot water H, with sensors S2, S3, S4, S5, S6 representing progressively warmer water temperatures, respectively. If, for example, medium warm water is desired, then a user may point a finger generally toward sensor S4. If the temperature is not as warm as desired, then the user may point a finger generally toward, including between, one or more of sensors S5, S6, and S7. Conversely, if the temperature is not as cool as desired, then the user may point a finger generally toward, including between, one or more of sensors S1, S2, and S3.

First LED array 940-1 has a first plurality of LEDs corresponding to the first plurality of sensors S1, S2, S3, S4, S5, S6, and S7 in first sensor array 938-1, and is located on body 934 in a predetermined pattern, such as a vertical column, to provide a visual indication of a water temperature selected via first sensor array 938-1. For example, the top LED may correspond to cold water and the bottom LED may correspond to hot water, with the intermediate LEDs representing progressively warmer water temperatures, respectively, from top to bottom. Also, LEDS of various colors may be used, e.g., a blue LED may represent cold water, a red LED may represent hot water, and various shades of green through yellow LEDs may represent progressively warmer water temperatures.

Second sensor array 938-2 has a first plurality of sensors, individually identified as sensors S11, S12, S13, S14, S15, S16, and S17 in this example, and is located on body 934 in a predetermined pattern, such as a vertical column. Second sensor array 938-2 provides a second sensor array output signal corresponding to a position of an object in relation to the respective locations of the second plurality of sensors S11, S12, S13, S14, S15, S16, and S17 in second sensor array 938-2. Second sensor array 938-2 supplies the second sensor array output signal to control module 848 via communication link 850.

For example, second sensor array 938-2 may be configured as a flow volume controller, wherein sensor S11 represents full OFF and sensor S17 represents full ON, with sensors S12, S13, S14, S15, S16 representing progressively higher flow volumes, respectively. If, for example, a medium stream of water is desired, then a user may point a finger generally toward sensor S14. If the flow volume is not as high as desired, then the user may point a finger generally toward, including between, one or more of sensors S15, S16, and S17. Conversely, if the flow volume is higher than desired, then the user may point a finger generally toward, including between, one or more of sensors S11, S12, and S13.

Second LED array 940-2 has a second plurality of LEDs corresponding to the second plurality of sensors S11, S12, S13, S14, S15, S16, and S17 in second sensor array 938-2, and is located on body 934 in a predetermined pattern, such as a vertical column, to provide a visual indication of a flow volume of a water flow selected via second sensor array 938-2. For example, the top LED may correspond to full OFF and the bottom LED may correspond to full ON, with the intermediate LEDs representing progressively higher flow volumes, respectively, from top to bottom. Also, LEDS of various colors may be used, e.g., a blue LED may represent full OFF, a red LED may represent full ON, and various shades of green through yellow LEDs may represent progressively higher flow volumes.

During operation, each of first electrically-operated valve 818 and second electrically-operated valve 820 may be placed in an ON state when the detection signal is received by control module 848 from object sensor 936, and the degree of opening of valves 818-3 and/or 820-3 may be dependent on the temperature signal received by control module 848 from a temperature control sensor array, e.g., first sensor array 938-1, of controller 906 and/or on the flow volume signal received by control module 848 from a flow volume sensor array, e.g., second sensor array 938-2, of controller 906.

In the embodiment of FIG. 10, certain components were shown as separate devices for ease of discussion. However, those skilled in the art will recognize that two or more of the devices may be incorporated into a unitary device, if desired. For example, it is contemplated that controller 906, first valve assembly 804 and control module 848 may be combined as an above-the-countertop unitary temperature/flow volume regulator valve assembly.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A faucet, comprising:
a spout defining a primary flow path;
a first flow path coupled to said primary flow path of said spout;
a first solenoid-operated valve coupled into said first flow path to control a first water flow through said first flow path;
a second flow path coupled to said primary flow path of said spout;
a second solenoid-operated valve coupled into said second flow path to control a second water flow through said second flow path;
a control device communicatively coupled to each of said first solenoid-operated valve and said second solenoid-operated valve, said control device including a sensor that sends a signal to said first solenoid-operated valve to place said first solenoid-operated valve in an ON state and to said second solenoid-operated valve to place said second solenoid-operated valve in an ON state when said sensor detects the presence of an object; and
a temperature control coupled into said first flow path and coupled into said second flow path to regulate a water temperature in said primary flow path.

2. The faucet of claim 1, further comprising a fluid volume control coupled into said first flow path and coupled into said second flow path to regulate a volume of water in said primary flow path when at least one of said first solenoid-operated valve and said second solenoid-operated valve is in said ON state.

3. A faucet, comprising:
a spout defining a primary flow path;
a first flow path coupled to said primary flow path of said spout;
a first solenoid-operated valve coupled into said first flow path to control a first water flow through said first flow path;
a second flow path coupled to said primary flow path of said spout;
a second solenoid-operated valve coupled into said second flow path to control a second water flow through said second flow path;
a control device communicatively coupled to each of said first solenoid-operated valve and said second solenoid-operated valve, said control device including a sensor that sends a signal to said first solenoid-operated valve to place said first solenoid-operated valve in an ON state and to said second solenoid-operated valve to place said second solenoid-operated valve in an ON state when said sensor detects the presence of an object;
a first auxiliary flow path connected in parallel with said first solenoid-operated valve;
a second auxiliary flow path connected in parallel with said second solenoid-operated valve; and
a flow control device coupled into said first auxiliary flow path and into said second auxiliary flow path.

4. The faucet of claim 3, wherein said flow control device is a fluid volume control providing, when in an ON state, a manual bypass of said first solenoid-operated valve when said first solenoid-operated valve is in an OFF state and providing a manual bypass of said second solenoid-operated valve when said second solenoid-operated valve is in an OFF state.

5. The faucet of claim 4, wherein when each of said first solenoid-operated valve and said second solenoid-operated valve is in an ON state, said fluid volume control is in effect bypassed.

6. The faucet of claim 4, wherein each of said first flow path and said first auxiliary flow path carries cold water and each of said second flow path and said second auxiliary flow path carries hot water, said faucet further comprising a temperature control coupled to each of said first flow path, said first auxiliary flow path, said second flow path and said second auxiliary flow path to regulate a water temperature in said primary flow path.

7. The faucet of claim 4, wherein said flow control device is an ON/OFF valve assembly coupled into said first auxiliary flow path and into said second auxiliary flow path.

8. The faucet of claim 7, wherein said ON/OFF valve assembly provides, when in an ON state, a bypass of said first solenoid-operated valve when said first solenoid-operated valve is in an OFF state and providing a bypass of said second solenoid-operated valve when said second solenoid-operated valve is in an OFF state.

9. The faucet of claim 7, wherein when each of said first solenoid-operated valve and said second solenoid-operated valve is in an ON state, said ON/OFF valve assembly when in an OFF state is bypassed.

10. The faucet of claim 7, wherein each of said first flow path and said first auxiliary flow path carries cold water and each of said second flow path and said second auxiliary flow path carries hot water, said faucet further comprising a temperature control coupled to each of said first flow path, said first auxiliary flow path, said second flow path and said second auxiliary flow path to regulate a water temperature in said primary flow path.

11. The faucet of claim 10, further comprising a fluid volume control coupled to each of said first flow path, said first auxiliary flow path, said second flow path and said second auxiliary flow path to regulate a water volume in said primary flow path.

12. The faucet of claim 10, wherein said temperature control is a thermostatic valve.

13. A faucet, comprising:
a spout defining a primary flow path;
a first flow path coupled to said primary flow path of said spout;
a first electrically-operated valve coupled into said first flow path to control a first water flow through said first flow path;
a second flow path coupled to said primary flow path of said spout;
a second electrically-operated valve coupled into said second flow path to control a second water flow through said second flow path; and
a control device communicatively coupled to each of said first electrically-operated valve and said second electrically-operated valve, said control device including a sensor that sends a signal to said first electrically-operated valve to place said first electrically-operated valve in an ON state and to said second electrically-operated valve to place said second electrically-operated valve in an ON state when said sensor detects the presence of an object,
wherein each said ON state includes a variable range of flow volumes, said signal individually operating said first electrically-operated valve and second electrically-operated valve to regulate a volume of water in said primary flow path.

14. The faucet of claim 13, wherein said first flow path carries cold water and said second flow path carries hot water, said faucet further comprising:
a digital thermostatic unit coupled into said first flow path and coupled into said second flow path; and
said control device being communicatively coupled to said digital thermostatic unit and providing temperature control signals to said digital thermostatic unit to regulate a water temperature in said primary flow path.

15. The faucet of claim 14, said control device including a digital temperature readout display.

16. The faucet of claim 13, wherein said control device controls an ON/OFF status of said sensor.

17. The faucet of claim 13, further comprising:
a filtration unit coupled to said primary flow path of said spout; and
said control device being communicatively coupled to filtration unit to control an ON/OFF status of said filtration unit.

18. The faucet of claim 13, wherein said sensor is one of an infrared control sensor and a radar control sensor.

19. The faucet of claim 13, wherein each of said first electrically-operated valve and second electrically-operated valve is a motorized valve.

20. A faucet assembly, comprising:
a spout defining a primary flow path;
a first valve assembly providing water flow regulation and water temperature regulation, said first valve assembly having a first input port, a second input port and a first output port;
a first water supply path coupled to said first input port of said first valve assembly;
a second water supply path coupled to a second input port of said first valve assembly;
a third flow path coupled between said output port of said first valve assembly and said primary flow path of said spout;
a second valve assembly providing at least one of water flow regulation and water temperature regulation, said second valve assembly having a third input port, a fourth input port and a second output port;
a fourth flow path coupled between said third input port and said first water supply path;
a fifth flow path coupled between said fourth input port and said second water supply path;
a sixth flow path coupled between said second output port of said second valve assembly and said primary flow path of said spout;
an electrically-operated valve coupled into said sixth flow path to control a water flow through said second valve assembly;
a flow sensor coupled into said third flow path to detect a water flow through said first valve assembly;
an object sensor to detect a presence of an object; and
a switching device communicatively coupled to said flow sensor, said object sensor, and said electrically-operated valve, said switching device being configured such that if a water flow is detected in said third flow path by said flow sensor, then said electrically-operated valve is retained in an OFF state.

21. The faucet assembly of claim 20, said switching device being configured such that if a water flow is detected in said third flow path by said flow sensor, then said electrically-operated valve is disabled.

22. The faucet assembly of claim 20, said switching device being configured such that if a water flow is detected in said third flow path by said flow sensor, then said object sensor is electrically disengaged from said electrically-operated valve.

23. The faucet assembly of claim 20, said switching device being configured such that if no water flow is detected in said third flow path by said flow sensor, then said electrically-operated valve is enabled to operate in accordance with a detection signal supplied by said object sensor.

24. The faucet assembly of claim 23, wherein said electrically-operated valve is placed in an ON state when said detection signal is received by said switching device.

25. The faucet assembly of claim 20, wherein said electrically-operated valve is one of a solenoid operated valve and a motor-operated valve.

26. A faucet assembly, comprising:
a spout defining a primary flow path;
a first valve assembly providing at least one of water flow regulation and water temperature regulation, said first valve assembly having a first electrically-operated valve, a second electrically-operated valve, a first input port, a second input port, and a first output port, said first electrically-operated valve being coupled between said first input port and said first output port and said second electrically-operated valve being coupled between said second input port and said first output port;
a first water supply path coupled to said first input port of said first valve assembly;
a second water supply path coupled to said second input port of said first valve assembly;
a third flow path coupled between said output port of said first valve assembly and said primary flow path of said spout;
a second valve assembly providing water flow regulation and water temperature regulation, said second valve assembly having a third input port, a fourth input port and a second output port;
a fourth flow path coupled between said third input port and said first water supply path;
a fifth flow path coupled between said fourth input port and said second water supply path;
a sixth flow path coupled between said second output port of said second valve assembly and said primary flow path of said spout;
a flow sensor coupled into said sixth flow path for detecting a water flow through said second valve assembly;
an object sensor for detecting a presence of an object; and
a switching device communicatively coupled to said flow sensor, said object sensor, said first electrically-operated valve, and said second electrically-operated valve, said switching device being configured such that if a water flow is detected in said sixth flow path by said flow sensor, then each of said first electrically-operated valve and said second electrically-operated valve is retained in an OFF state.

27. The faucet assembly of claim 26, said switching device being configured such that if a water flow is detected in said sixth flow path by said flow sensor, then each of said first electrically-operated valve and said second electrically-operated valve is disabled.

28. The faucet assembly of claim 26, said switching device being configured such that if a water flow is detected in said sixth flow path by said flow sensor, then said object sensor is electrically disengaged from each of said first electrically-operated valve and said second electrically-operated valve.

29. The faucet assembly of claim 26, said switching device being configured such that if no water flow is detected in said sixth flow path by said flow sensor, then each of said first electrically-operated valve and said second electrically-operated valve is enabled to operate in accordance with a detection signal supplied by said object sensor.

30. The faucet assembly of claim 29, wherein each of said first electrically-operated valve and said second electrically-operated valve is placed in an ON state when said detection signal is received by said switching device.

31. A faucet assembly, comprising:
a spout defining a primary flow path;
a first valve assembly providing at least one of water flow regulation and water temperature regulation, said first valve assembly having a first electrically-operated valve, a second electrically-operated valve, a first input port, a second input port, and a first output port, said first electrically-operated valve being coupled between said first input port and said first output port and said second electrically-operated valve being coupled between said second input port and said first output port;
a first water supply path coupled to said first input port of said first valve assembly;
a second water supply path coupled to said second input port of said first valve assembly;
a third flow path coupled between said first output port of said first valve assembly and said spout;
a first sensor array having a first plurality of sensors located in a predetermined pattern, said first sensor array providing a first sensor array output signal corresponding to a position of an object in relation to the respective locations of said first plurality of sensors in said first sensor array; and
a control module communicatively coupled to said first electrically-operated valve, said second electrically-operated valve, and said first sensor array, said control module controlling said first electrically-operated valve and said second electrically-operated valve to open by an amount as determined from said first sensor array output signal.

32. The faucet assembly of claim 31, wherein said first sensor array is configured as one of a temperature controller and a fluid volume controller.

33. The faucet assembly of claim 32, wherein said first sensor array is configured as a temperature controller, said faucet assembly further comprising an LED array having a plurality of LEDs located in a predetermined pattern to provide a visual indication of a water temperature selected via said first sensor array.

34. The faucet assembly of claim 32, wherein said first sensor array is configured as a fluid volume controller, said faucet assembly further comprising an LED array having a plurality of LEDs located in a predetermined pattern to provide a visual indication of a water flow volume selected via said first sensor array.

35. The faucet assembly of claim 32, further comprising a second sensor array having a second plurality of sensors located in a predetermined pattern, said second sensor array providing a second sensor array output signal corresponding to a position of an object in relation to the respective locations of said second plurality of sensors in said second sensor array; and
said control module being communicatively coupled to said second sensor array, said control module controlling said first electrically-operated valve and said second electrically-operated valve to open by an amount as determined by said second sensor array output signal, wherein said first sensor array is configured as one of a temperature controller and a fluid volume controller and said second sensor array is configured as the other of said temperature controller and said fluid volume controller.

36. The faucet assembly of claim 35, wherein said first sensor array is configured as said temperature controller and said second sensor array is configured as said fluid volume controller, said faucet assembly further comprising:
a first LED array having a first plurality of LEDs located in a predetermined pattern to provide a visual indication of a water temperature selected via said first sensor array; and
a second LED array having a second plurality of LEDs located in a predetermined pattern to provide a visual indication of a water flow volume selected via said second sensor array.

37. The faucet assembly of claim 31, further comprising:
a second valve assembly providing water flow regulation and water temperature regulation, said second valve assembly having a third input port, a fourth input port and a second output port;
a fourth flow path coupled between said third input port and said first water supply path;
a fifth flow path coupled between said fourth input port and said second water supply path;
a sixth flow path coupled between said second output port of said second valve assembly and said primary flow path of said spout;
a flow sensor coupled into said sixth flow path for detecting a water flow through said second valve assembly;
an object sensor for detecting a presence of an object; and
a switching device communicatively coupled to said flow sensor, said object sensor, said first electrically-operated valve, and said second electrically-operated valve, said switching device being configured such that if a water flow is detected in said sixth flow path by said flow sensor, then each of said first electrically-operated valve and said second electrically-operated valve is retained in an OFF state.

38. The faucet assembly of claim 37, said switching device being configured such that if a water flow is detected in said sixth flow path by said flow sensor, then each of said first electrically-operated valve and said second electrically-operated valve is disabled.

39. The faucet assembly of claim 37, said switching device being configured such that if a water flow is detected in said sixth flow path by said flow sensor, then said object sensor is electrically disengaged from each of said first electrically-operated valve and said second electrically-operated valve.

40. The faucet assembly of claim 37, said switching device being configured such that if no water flow is detected in said sixth flow path by said flow sensor, then each of said first electrically-operated valve and said second electrically-operated valve is enabled to operate in accordance with a detection signal supplied by said object sensor.

41. The faucet assembly of claim 40, wherein each of said first electrically-operated valve and said second electrically-operated valve is placed in an ON state when said detection signal is received by said switching device.

42. The faucet assembly of claim 31, wherein each of said first electrically-operated valve and said second electrically-operated valve is a motor-operated valve.

43. An electronic controller for a faucet, comprising:
a body; and
a first sensor array having a first plurality of sensors located in a predetermined pattern on said body, said first sensor array providing a first sensor array output signal corresponding to a position of an object in relation to the respective locations of said first plurality of sensors in said first sensor array.

44. The controller of claim 43, wherein said first sensor array is configured as one of a temperature controller and a fluid volume controller.

45. The controller of claim 43, further comprising a second sensor array having a second plurality of sensors located in a predetermined pattern on said body, said second sensor array providing a second sensor array output signal corresponding to a position of an object in relation to the respective locations of said second plurality of sensors in said second sensor array.

46. The controller of claim 45, wherein said first sensor array is configured as a temperature controller and said second sensor array is configured as a fluid volume controller, said controller further comprising:
a first LED array having a first plurality of LEDs located in a predetermined pattern on said body to provide a visual indication of a water temperature selected via said first sensor array; and
a second LED array having a second plurality of LEDs located in a predetermined pattern on said body to provide a visual indication of a water flow volume selected via said second sensor array.
